(19) United States
(12) Patent Application Publication
(10) Pub. No.: US 2024/0152988 A1
(43) Pub. Date: May 9, 2024

(54) INFORMATION PROCESSING APPARATUS, UNPROFITABLE PRODUCT DETERMINATION ASSISTANCE METHOD, AND NON-TRANSITORY COMPUTER-READABLE MEDIUM

(71) Applicant: NEC Corporation, Minato-ku, Tokyo (JP)

(72) Inventor: Takami SATO, Tokyo (JP)

(73) Assignee: NEC Corporation, Minato-ku, Tokyo (JP)

(21) Appl. No.: 18/273,107

(22) PCT Filed: Jun. 22, 2021
(86) PCT No.: PCT/JP2021/023606

§ 371 Date: Jul. 19, 2023

(51) Int. Cl. G06Q 30/0601; G06Q 10/087

(52) U.S. Cl. CPC G06Q 30/0629; G06Q 10/087

(57) ABSTRACT

A server apparatus (10) includes an image processing unit (110), a comparison unit (120), and an output unit (130). The image processing unit (110) processes an image of a product shelf in which a target product that is currently unprofitable in a shop is captured and identifies at least one of a shelf space allocation state of the target product and a state of the surroundings of the target product. The comparison unit (120) compares an identification result of at least one of the shelf space allocation state of the target product and the state of the surroundings of the target product with comparison information indicating one or more predetermined confirmation items for the target product. The output unit (130) outputs a comparison result between the identification result and the comparison information.

### TECHNICAL FIELD

The present invention relates to a technique that assists product marketing tasks at a retail shop.

### BACKGROUND ART

A wide variety of products are sold in shops. Once sales data for each product have been accumulated for a certain period of time, selling products and unprofitable products can be identified. Unprofitable products will be replaced with selling products or other new products in order to improve sales across the shop.

Examples of a technique for assisting in formulation of a product sales improvement plan are disclosed, for example, in the following Patent Documents 1 to 4.

Patent Document 1 discloses a technique that extracts a product of which sales are lower than a predetermined level from among a plurality of products, calculates the occupancy state of the extracted product in each display area, and outputs the occupancy state of the extracted product calculated for each display area.

Patent Document 2 discloses a technique that displays, on a screen, information about a sales method (contents of a flyer, a product sales price, a product display method, and the like) that has been implemented by a distribution shop based on the shop's own “hypothesis” together with actual sales performance in order to assist verification of the hypothesis.

Patent Document 3 discloses a technique that identifies, as an unprofitable product, and visualizes a product for which the period between a set date stored in a product file and a first sales date stored in an accumulated sales file is equal to or longer than a specified period.

Patent Document 4 discloses a technique that performs analysis using position information indicating where products are lined up in a product shelf and sales status information indicating what kind of products are selling or not selling, and provides the result of the analysis to a shop side.

### RELATED DOCUMENT

### Patent Document

Patent Document 1: Japanese Patent Application Publication No. 2017-138783
Patent Document 2: Japanese Patent Application Publication No. 2006-293966
Patent Document 3: Japanese Patent Application Publication No. 2002-133531
Patent Document 4: Japanese Patent Application Publication No. 2002-109177

### SUMMARY OF INVENTION

### Technical Problem

In retail or other shops, sales of a product can be significantly affected by the display state of the product. Therefore, even if a product can be determined as an unprofitable product based on sales performance alone, there may be cases where sufficient sales can be expected by changing the condition of the product at the time of sale.

The present invention was made in view of the above problem. One of the objectives of the present invention is to provide a technique that assists a shop assistant in finding a product that has a potential to increase sales from among products that are currently unprofitable.

### Solution to Problem

An information processing apparatus according to the present disclosure includes:

an image processing unit that processes an image of a product shelf in which a target product that is currently unprofitable in a shop is captured and identifies at least one of a shelf space allocation state of the target product and a state of surroundings of the target product;
a comparison unit that compares an identification result of at least one of the shelf space allocation state of the target product and the state of the surroundings of the target product with comparison information indicating one or more predetermined confirmation items for the target product; and
an output unit that outputs a comparison result between the identification result and the comparison information.

An unprofitable product determination assistance method according to the present disclosure includes:
by a computer,
processing an image of a product shelf in which a target product that is currently unprofitable in a shop is captured and identifying at least one of a shelf space allocation state of the target product and a state of surroundings of the target product;
comparing an identification result of at least one of the shelf space allocation state of the target product and the state of the surroundings of the target product with comparison information indicating one or more predetermined confirmation items for the target product; and
outputting a comparison result between the identification result and the comparison information.

A program according to the present disclosure causes a computer to function as:
an image processing unit that processes an image of a product shelf in which a target product that is currently unprofitable in a shop is captured and identifies at least one of a shelf space allocation state of the target product and a state of surroundings of the target product;
a comparison unit that compares an identification result of at least one of the shelf space allocation state of the target product and the state of the surroundings of the target product with comparison information indicating one or more predetermined confirmation items for the target product; and
an output unit that outputs a comparison result between the identification result and the comparison information.

### Advantageous Effects of Invention

According to the present invention, a technique is provided to assist a shop assistant in finding a product that has a potential to increase sales from among products that are currently unprofitable.

### BRIEF DESCRIPTION OF THE DRAWINGS

FIG. 1 It is a diagram illustrating the configuration of an unprofitable product determination assistance system according to a first example embodiment.

FIG. 2 It is a diagram illustrating an example of comparison information.

FIG. 3 It is a block diagram illustrating the hardware configuration of a server apparatus.

FIG. 4 It is a flowchart illustrating the flow of processing performed by the server apparatus according to the first example embodiment.

FIG. 5 It is a diagram illustrating an example of information that is output from the server apparatus.

FIG. 6 It is a diagram illustrating the configuration of an unprofitable product determination assistance system according to a second example embodiment.

FIG. 7 It is a flowchart illustrating the flow of processing performed by a server apparatus according to the second example embodiment.

### DESCRIPTION OF EMBODIMENTS

The following describes example embodiments of the present invention with reference to the drawings. Note that, in all the drawings, like components are given like signs, and descriptions thereof will not be repeated as appropriate. In the block diagrams, each block represents a functional unit component, rather than a hardware unit component unless otherwise described. The orientation of the arrow in the drawings is intended to facilitate the understanding of the flow of information and does not limit the direction of communication (one-way communication/two-way communication) unless otherwise described.

### First Example Embodiment

### <Example of Functional Configuration>

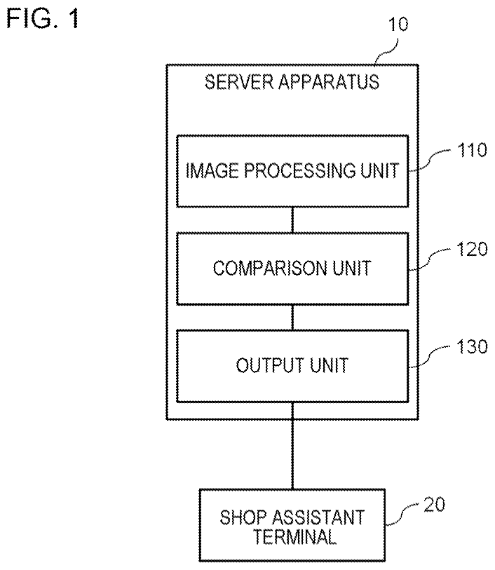

The present specification describes a system that assists in determining whether a product classified as an unprofitable product in a shop is appropriate for that classification. FIG. 1 is a diagram illustrating the configuration of an unprofitable product determination assistance system according to a first example embodiment. The unprofitable product determination assistance system 1 illustrated in FIG. 1 is configured to include a server apparatus 10 and a shop assistant terminal 20.

The image processing unit 110 acquires an image in which a target product that is currently an unprofitable product in a shop is captured as a processing target image. The processing target image is generated, for example, by an employee of the shop capturing a location (for example, a product shelf or a wagon) where the target product is displayed using a camera function of a shop assistant terminal 20.

Note that the target product (the unprofitable product) may be identified in accordance with a predetermined rule based on the sales performance data of each product managed in the shop. For example, a product whose cumulative sales during a predetermined period (such as the latest one month) or cumulative sales from the start of sales to the present time do not meet a predetermined criterion may be identified as a target product (an unprofitable product). The processing of identifying the target product (the unprofitable product) may be performed by a shop assistant or by a system. For example, a shop assistant may check the sales performance data, extract a product that is currently an unprofitable product, and input information designating such a product as a target product into the unprofitable product determination assistance system 1 (the server apparatus 10 in the example of FIG. 1) via the shop assistant terminal 20. Alternatively, for example, a component of the unprofitable product determination assistance system 1 may access the sales performance data and automatically extract a product that is identified in accordance with the above-described rule as a target product.

The image processing unit 110 identifies at least one of the shelf space allocation state of a target product and the state of the surrounding of the target product based on the acquired processing target image. The image processing unit 110 can utilize a model that has been constructed, for example, by machine learning in order to detect a target product from the processing target image and identify at least one of the shelf space allocation state of the target product and the state of the surrounding of the target product. Here, the “shelf space allocation state” includes, for example, the position of a product in a product display shelf (for example, the second shelf from the top), the position of the product in the shop (for example, the entrance side/back side of the shop), the number of rows (faces) of the product, and the orientation of the product (whether the product is facing front or not). The “state of surroundings” includes, for example, the distribution state of classifications of other products (product categories) arranged around the target product, the distribution state of the appearance characteristics (representative colors of products, shapes of products) of other products arranged around the target product, the arrangement state (a relative position) of the target product with reference to related products (for example, consumables and maintenance products, such as razors and replacement blades), the arrangement state (a relative position with reference to the relevant product) of an information display medium such as a shelf tag (an electronic shelf tag, a price card) and a pop advertisement, and the state of an obstacle in front of the target product (presence or absence of an obstacle). The information identified from the processing target image by the image processing unit 110 relates to one or more confirmation items included in the comparison information that is used by the comparison unit 120 as described below.

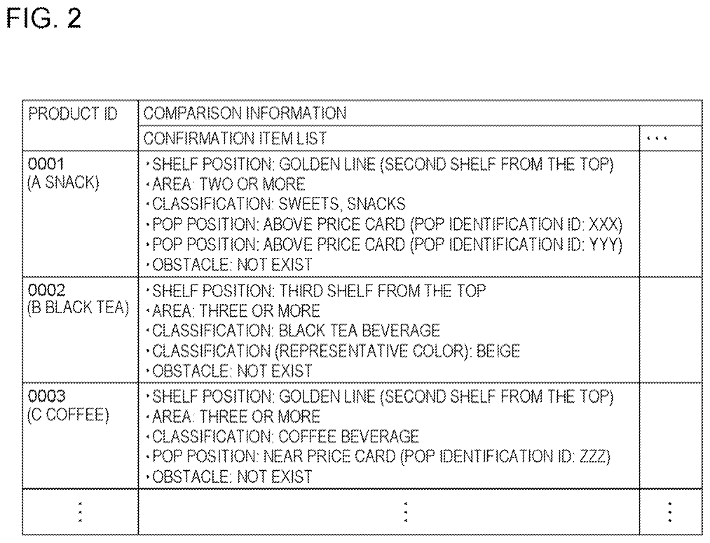

The comparison unit 120 compares the identification result of at least one of the shelf space allocation state of the target product and the state of the surroundings of the target product with the comparison information. The comparison information includes one or more predetermined confirmation items for at least one of the shelf space allocation state of the target product and the state of the surroundings of the target product. FIG. 2 is a diagram illustrating an example of the comparison information. FIG. 2 illustrates a database storing comparison information that associates the identification information of each product and information defining one or more confirmation items of each product. The comparison unit 120 can read out comparison information relating to the target product from a database as illustrated in FIG. 2, based on the detection result of the target product (the unprofitable product) by the image processing unit 110. For example, it is assumed that “A snack (product ID: 0001)” is an unprofitable product in a shop as determined based on the sales performance. Then, it is also assumed that the image processing unit 110 detects “A Snack (Product ID: 0001)” as a result of analyzing the processing target image. In this case, the comparison unit 120 can read out the comparison information stored in the first line of FIG. 2 based on the detection result of the “A snack (product ID: 0001).” Then, the comparison unit 120 compares the identification result of at least one of the shelf space allocation state and the state of the surroundings of the target product obtained as a result of the processing of the image processing unit 110 with the read-out comparison information (a list of confirmation items).

The confirmation items included in the comparison product may be determined, for example, based on the shelf space allocation state and state of the surroundings that are recommended for the target product. Then, the comparison information defining the confirmation items (for example, FIG. 2) is generated and stored in a storage area accessible from the comparison unit 120 (for example, the storage of the server apparatus 10). The “recommended state” for the product can be determined, for example, by a person, in charge of drawing up the shelf space allocation plan, while examining various perspectives. In addition, the “recommended state” for a product may be determined based on at least one of the shelf space allocation state of the product and the state of the surroundings of the target product in a shop where sales of the product exceed a predetermined criterion.

The output unit 130 outputs the result of comparing the identification result and the comparison information. The output unit 130, for example, generates a screen that visually displays one or more items deemed appropriate and one or more items deemed inappropriate (that is, a difference from the comparison information) among the confirmation items included in the comparison information, and causes the screen to be displayed on the display of the shop assistant terminal 20.

### <Hardware Configuration Example>

Each functional component of the server apparatus 10 may be achieved in hardware (for example, a hard-wired electronic circuit) that achieves each functional component, or may be achieved in a combination of hardware and software (for example, a combination of an electronic circuit and a program controlling the electronic circuit). Hereinafter, a case where each functional component of the server apparatus 10 is achieved by a combination of hardware and software is further described.

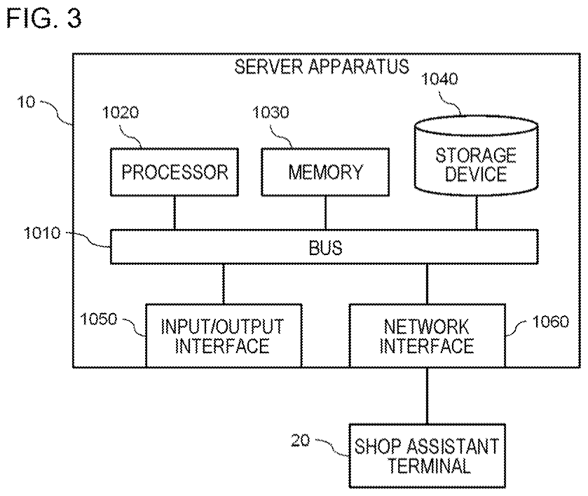

FIG. 3 is a block diagram illustrating the hardware configuration of the server apparatus 10. The server apparatus 10 has a bus 1010, a processor 1020, a memory 1030, a storage device 1040, an input/output interface 1050, and a network interface 1060.

The bus 1010 is a data transmission path for the processor 1020, the memory 1030, the storage device 1040, the input/output interface 1050, and the network interface 1060 to send and receive data to and from each other.

However, the method of connecting the processor 1020 and the like to each other is not limited to a bus connection.

The processor 1020 is a processor achieved in a CPU (Central Processing Unit), a GPU (Graphics Processing Unit), or the like.

The memory 1030 is a main storage achieved using a random access memory (RAM) or the like.

The storage device 1040 is an auxiliary storage achieved in a hard disk drive (HDD), a solid state drive (SSD), a memory card, a read only memory (ROM), or the like. The storage device 1040 stores a program module that achieves each function of the server apparatus 10 (such as the image processing unit 110, the comparison unit 120, and the output unit 130). The processor 1020 loads and executes each program module on the memory 1030, thereby enabling a function related to each program module.

The input/output interface 1050 is an interface for connecting the server apparatus 10 to various input/output equipment. For example, an input/output interface 1050 may be connected to input equipment such as a mouse, a keyboard, and/or a touch panel, and output equipment such as a display, and/or a speaker.

The network interface 1060 is an interface for connecting the server apparatus 10 to other devices on a network. This network is, for example, a local area network (LAN) and/or a wide area network (WAN). The method by which the network interface 1060 connects to the network may be a wireless connection or a wired connection. The server apparatus 10 may communicate with the shop assistant terminal 20 via the network interface 1060. For example, the server apparatus 10 (the image processing unit 110) may acquire a processing target image captured by the shop assistant terminal 20 or other external apparatuses. The output unit 130 can also transmit, via the network interface 1060, the result of the comparison between the identification result based on the processing target image and the comparison information (for example, the data of the screen in FIG. 3) to the shop assistant terminal 20.

Note that the hardware configuration illustrated in FIG. 3 is only an example. The hardware configuration of the server apparatus 10 according to the present disclosure is not limited to the example of FIG. 3.

### <Processing Flow>

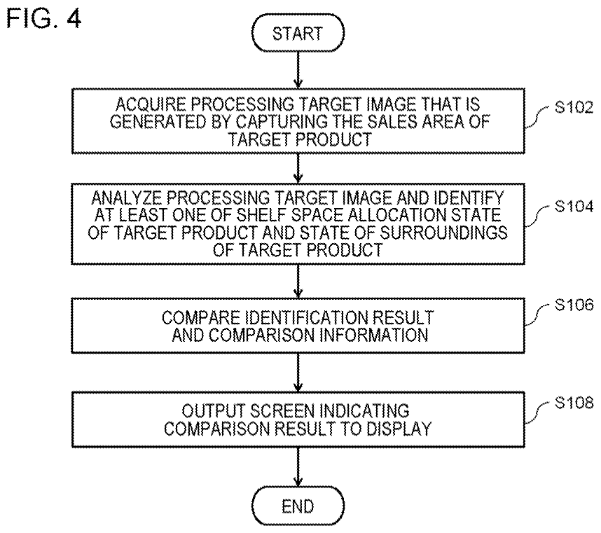

FIG. 4 illustrates the flow of processing performed by the server apparatus according to the first example embodiment. FIG. 4 is a flowchart illustrating the flow of processing performed by the server apparatus 10 according to the first example embodiment.

The image processing unit 110 acquires a processing target image that is generated by capturing the sales area of the target product using an image capturing apparatus (S102). As described above, the processing target image is captured, for example, using a camera function of the shop assistant terminal 20. The image processing unit 110 analyzes the processing target image and identifies at least one of the shelf space allocation state of the target product and the state of the surroundings of the target product (S104).

The comparison unit 120 compares the identification result obtained by the processing of S104 with the comparison information that has been prepared in advance for the target product (S106). By comparing the confirmation items included in the comparison information with the identification result obtained by analyzing the processing target image, the comparison unit 120 can select one or more appropriate items and one or more inappropriate items among the confirmation items of the comparison information.

The output unit 130 generates a screen indicating the processing result (the comparison result) by the comparison unit 120 and outputs the screen to a display such as the shop assistant terminal 20 (S108).

### <Specific Examples of Output>

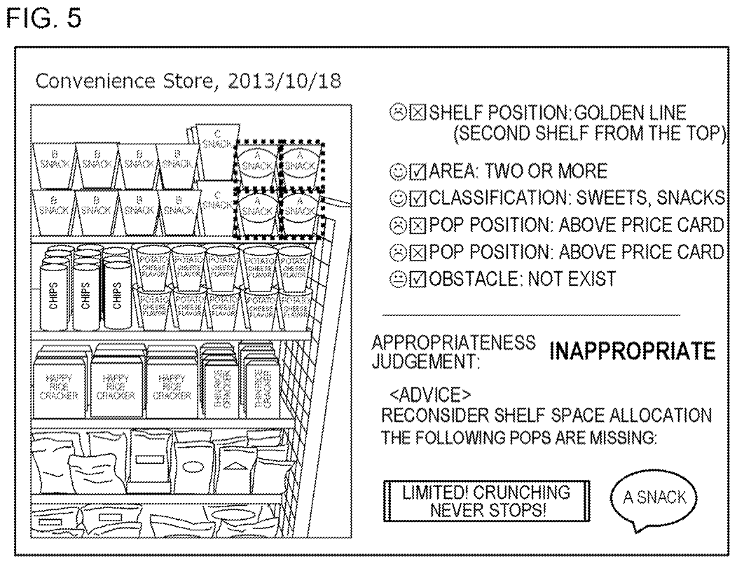

As a result of the processing by the functional components of the above described server apparatus 10, information such as the one illustrated in FIG. 5 is displayed on the display of the shop assistant terminal 20. FIG. 5 is a diagram illustrating an example of information that is output from the server apparatus 10.

In FIG. 5, “A snack” is identified as a target product, and a comparison result is illustrated of a case where an image of the state of the target product displayed at the right end of the top shelf in a product shelf is acquired as a processing target image.

In this case, the image processing unit 110 can analyze the processing target image and generate, for example, the following information as an identification result for the A snack:
Shelf Position: Top shelf (first shelf)
Area: 4 pieces (two rows×double stacked)
Classification: Sweets, snacks
Pop: - (not detected)
Obstacle: - (not detected)
   Note that, among the above-described identification result, “shelf position” and “area” fall under the “shelf space allocation state.” Among the above identification result, “classification,” “pop,” and “obstacle” fall under the “state of surroundings.”

Here, the image processing unit 110 can generate information about the “shelf position” as follows. First, the image processing unit 110 detects a target product and shelf boards of the product shelf. The image processing unit 110 can detect the target product and the shelf boards from the processing target image, for example, using a learning model that has been constructed in advance by machine learning. The image processing unit 110 can then identify, for example, on which shelf board of the product shelf the target product is arranged based on the relationship between the detected position of the target product and the detected positions of the shelf boards.

The image processing unit 110 can also generate information about the “area” as follows. The image processing unit 110 detects an individual target product from the processing target image, for example, using a learning model that has been constructed in advance by machine learning. The image processing unit 110 can assume the detected number of target products as information about the “area.”

The image processing unit 110 can also generate information about the “classification” as follows. The image processing unit 110 detects other products (products other than the target product) in the processing target image, for example, using a learning model that has been constructed in advance by machine learning. The image processing unit 110 then acquires information indicating the classification of each product, for example, by referring to a database (not illustrated) that stores various types of information about products using the identification results of other products as search information. The image processing unit 110 can use the classification information acquired for each product in order to generate information indicating the arrangement of the product classifications around the target product. The image processing unit 110 may also identify a representative color of each product and generate information about the arrangement of the representative color as information about the “classification.” In this case, the image processing unit 110 can acquire information about a representative color of each product from the database that stores various types of information about products. The image processing unit 110 may analyze the processing target image and identify a representative color in the image area relating to each product. Alternatively, the image processing unit 110 may identify, for each product detected from the processing target image, appearance characteristics such as a “product shape” other than the “representative color” described above and generate the arrangement of such appearance characteristics as information about “classification.” In this case, the image processing unit 110 can identify the shape of each product by analyzing each image area of each product using a known shape recognition algorithm. For example, if a product included in the processing target image is a beverage product, the image processing unit 110 can recognize a shape such as “plastic bottle,” “can,” and “paper pack” based on the image feature value that can be extracted from the image area of each product. In this way, the image processing unit 110 can acquire information indicating the distribution state of the appearance characteristics (representative colors and shapes) of products in the surroundings of the target product.

The image processing unit 110 can also generate information about “pop” as follows. The image processing unit 110 refers to a database (not illustrated) that stores various types of information related to pop advertisements and determines whether or not a pop advertisement is present in the processing target image. When no pop advertisement is detected in the processing target image, the image processing unit 110 generates information indicating that no pop advertisement was detected. On the other hand, when a pop advertisement is detected in the processing target image, the image processing unit 110 identifies a product relating to the detected pop advertisement based on the information stored in the database. When the identified product matches the target product, the image processing unit 110 calculates the positional relationship (relative position) between the target product detected in the processing target image and the pop advertisement and assumes the positional relationship as information about “pop.” Whereas, when the identified product does not match the target product, the image processing unit 110 generates information indicating that the pop advertisement was not detected.

The image processing unit 110 can also generate information about “obstacle” from the processing target image as follows. First, when the image processing unit 110 detects an object that does not correspond to a product (for example, a pop advertisement) in the processing target image, the image processing unit 110 infers a product (a product hidden by the obstacle) that is located behind the detected location of the object. The image processing unit 110 can then generate information indicating that “an obstacle is present” when the inferred product matches the target product, and generate information indicating that “no obstacle is present” when the inferred product does not match the target product. Note that the method of inferring a product hidden by an obstacle is not particularly limited. For example, the image processing unit 110 can use information indicating a shelf space allocation plan of a shop in order to identify a product relating to a location where an object has been detected and infer the product so identified as a product hidden by the above-described object. In this case, the information of the shelf space allocation plan of the shop is stored in advance, for example, in a storage device accessible from the server apparatus 10. The image processing unit 110 may also infer a product hidden by an object based on a difference from a past image of the same location (an image of a state in which the object does not exist). Alternatively, for example, the image processing unit 110 may infer a product located behind the detected object from an image feature value around the detected object. Specifically, character information of a shelf tag provided in the vicinity of a location where an object has been detected may be analyzed, and a product hidden by the object may be inferred based on the analysis result.

After the image processing unit 110 has analyzed the processing target image, the comparison unit 120 reads out comparison information relating to the “A snack” from the database and compares the information with the above-described identification result. When the comparison information illustrated in FIG. 2 is used, since the identification result is consistent with the comparison information in the confirmation items of “area,” “classification,” and “obstacle,” the comparison unit 120 determines that the confirmation items of “area,” “classification,” and “obstacle” are appropriate. On the other hand, since there is a discrepancy between the identification result and the comparison information in the confirmation items of the “shelf position” and “pop,” the comparison unit 120 determines that the confirmation items of the “shelf position” and “pop” are not appropriate.

The output unit 130 generates screen rendering data as illustrated in FIG. using the comparison result thus generated. For example, the output unit 130 generates screen data as illustrated in FIG. 5 by reading template data of a screen layout that has been prepared in advance in the storage area of the server apparatus 10 and setting information relating to the comparison result in each field of the template data. Also, as illustrated in FIG. 5, the output unit 130 can include an evaluation of the identification result based on the result of comparing the above-described identification result with the comparison information. In the example of FIG. 5, the output unit 130 outputs a message indicating that the display method of the target product is not appropriate because the “shelf position” and “pop” have been determined to be “inappropriate.” Also, as illustrated in FIG. 5, the output unit 130 may further include advice for items determined to be inappropriate. In the example of FIG. 5, the output unit 130 outputs a message prompting to reconsider the shelf space allocation and pop of the target product. The output unit 130 further outputs pop image data to be posted for the target product. The output unit 130 can, for example, acquire image data of the pop associated with the identification information of the pop included in the information of FIG. 2.

### Examples of Effects

According to the present example embodiment, when an unprofitable product is identified based on the sales, it is determined whether or not the display state of the unprofitable product is appropriate, and the result is output to, for example, a shop assistant terminal 20 used by a shop assistant. This allows a person who determines the shelf space allocation plan of the shop to analyze the cause of the product being unprofitable from aspects other than the sales. For example, when a result such as the one illustrated in FIG. 5 is obtained, the shop assistant can analyze such as “It is not that the product itself is unattractive, but that it does not attract the customer's attention due to another factor (display state).” In this way, the shop assistant can utilize the information provided by the system of the present disclosure in order to determine the true potential of the product that is currently unprofitable in the shop.

### Second Example Embodiment

The present example embodiment has a similar configuration to the first example embodiment, except for the points described below.

### <Example of Functional Configuration>

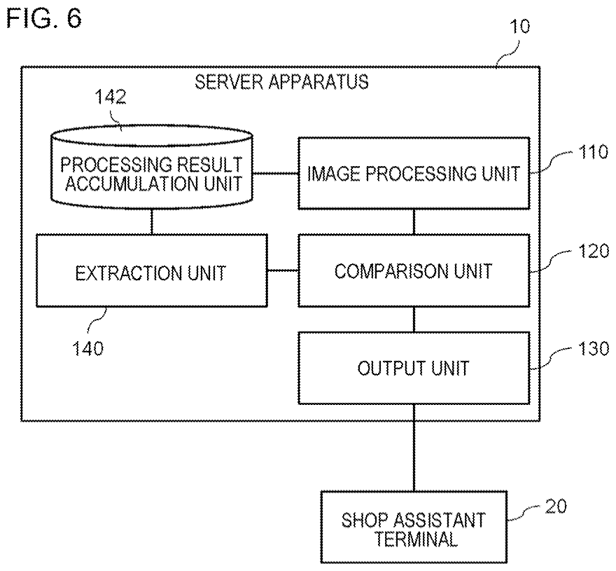

FIG. 6 is a diagram illustrating the configuration of an unprofitable product determination assistance system according to a second example embodiment. In the example of FIG. 6, the server apparatus 10 further has an extraction unit 140. In the present example embodiment, the image processing unit 110 accumulates an identification result obtained by analyzing a processing target image (an identification result regarding at least one of the shelf space allocation state of a target product and the surroundings of the target product) in a predetermined storage unit (the processing result accumulation unit 142 in FIG. 6) in association with the information of the target product and the information of the shop. When a certain target product is currently unprofitable in a plurality of shops, the extraction unit 140 extracts a condition common to the plurality of shops with regard to the display state of the target product based on the information accumulated in the processing result accumulation unit 142. For example, the extraction unit 140 can read a plurality of pieces of information (shop-by-shop information) for a certain target product stored in the processing result accumulation unit 142 and extract a condition common to the plurality of shops for how the target product is displayed. Here, the extraction unit 140 identifies a condition common to the plurality of shops, such as, for example, the location of the target product in the shop (the location when seen in the shop's plane view (such as the front side/back side with reference to the shop entrance), the location of the target product in the product shelf (the height: such as the nth shelf board of the shelf), and the classifications of products placed in the surrounding area. Note that the extraction unit 140 may extract a condition common to all the shops, or may extract a condition common to shops above a predetermined threshold.

If there is a display method of an unprofitable product common to a plurality of shops, such a display method may be influencing the sales of the product. By utilizing the condition extracted by the extraction unit 140, a measure can be taken in order to improve the sales of the unprofitable product.

### <Examples of Operation>

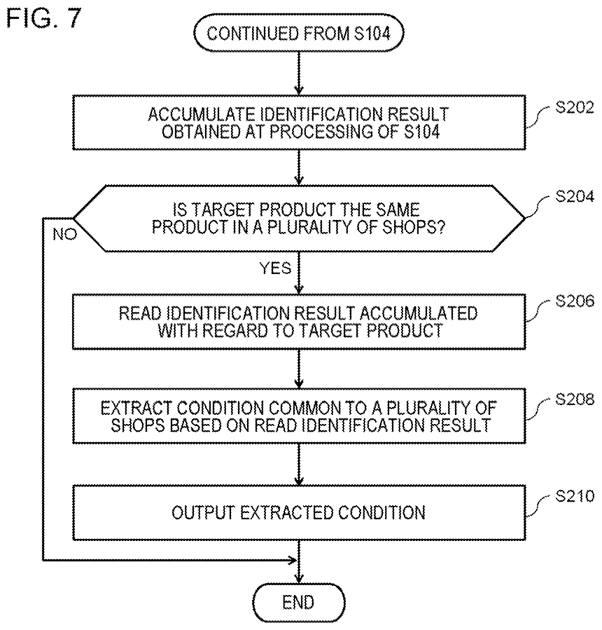

FIG. 7 is a flowchart illustrating the flow of processing performed by the server apparatus 10 according to the second example embodiment. In addition to the processing illustrated in the flowchart of FIG. 3, the server apparatus 10 according to the present example embodiment executes the processing illustrated in the flowchart of FIG. 7 (S202 to S210).

The image processing unit 110 accumulates the identification result obtained by the processing of S104 in the processing result accumulation unit 142 (S202). At this time, the image processing unit 110 accumulates the identification result in association with information indicating the shop where the processing target image that is used in obtaining the identification result is captured.

The extraction unit 140 refers to the processing result accumulation unit 142 in order to determine whether a target product (an unprofitable product) is the same product in a plurality of shops (S204). The extraction unit 140 can perform determination processing of S204 at an arbitrary timing.

When the target product (the unprofitable product) is the same product in a plurality of shops (S204: Yes), the extraction unit 140 reads out the identification results for the product at the plurality of shops that have been accumulated in the processing result accumulation unit 142 (S206). Then, the extraction unit 140 extracts, based on the content of the read identification results, a condition common to the product that is currently unprofitable in the plurality of shops (S208). Then, the extraction unit 140 outputs the extracted condition to a predetermined destination (an apparatus or a processing unit) (S210). A method for utilizing the condition extracted by the extraction unit 140 is described below.

### <Example 1 of Utilization of a Condition Extracted by the Extraction Unit 140>

As an example, the extraction unit 140 may output the extracted condition to, for example, a terminal of a manager supervising a plurality of shops. In this case, the manager can take steps such as checking on the terminal a condition common to the plurality of shops for the display state of the unprofitable product and issuing an instruction to each shop to quit such a display. As a result, it is possible to improve sales of the target product by correcting the display that may have adversely affected the sales of the target product as necessary in a plurality of shops.

### <Example 2 of Utilization of a Condition Extracted by the Extraction Unit 140>

As another example, the extraction unit 140 may add the extracted condition to the comparison information as a new confirmation item. For example, when a target product (an unprofitable product) is displayed on the “top shelf of a product shelf” in a plurality of shops, the extraction unit 140 extracts a condition that “the target product is arranged on the top shelf of a product shelf” as a new confirmation item. In this case, the extraction unit 140 adds the extracted condition to the comparison information as a “confirmation item indicating an inappropriate state.” As a result, in the comparison processing with the identification result obtained from the processing target image, the comparison unit 120 can further determine whether the current state is similar to the state added as a “confirmation item indicating an inappropriate state.” In this way, it is possible to improve sales of the target product by updating comparison information based on the performances in a plurality of shops.

Although the example embodiments of the present invention have been described above with reference to the drawings, the invention should not be construed as limited thereto, and various changes, improvements, and/or the like can be made based on the knowledge of those skilled in the art to the extent that they do not depart from the principle of the present invention. In addition, the plurality of components disclosed in the example embodiments can form various inventions in an appropriate combination. For example, some components may be removed from all the components illustrated in the example embodiments, or components of different example embodiments may be combined as appropriate. For example, the image processing unit 110, the comparison unit 120, and the output unit 130 may be provided in an information processing apparatus other than the server apparatus 10, such as a shop assistant terminal 20. In this case, the shop assistant terminal 20 can perform the processing described in the above-described example embodiments in a similar manner to the server apparatus 10.

Although a plurality of steps (processes) are described sequentially in the plurality of flowcharts used in the above descriptions, the execution order of the steps carried out in the example embodiments is not limited to the order in which the steps are described. In the example embodiments, the order of the illustrated steps can be changed to an extent that does not hinder the content. In addition, the above-described example embodiments and variations can be combined to the extent that does not conflict the contents.

A part or all of the above-described example embodiments may also be described as the following supplementary notes, but are not limited to:

1. An information processing apparatus including:
an image processing unit that processes an image of a product shelf in which a target product that is currently unprofitable in a shop is captured and identifies at least one of a shelf space allocation state of the target product and a state of surroundings of the target product;
a comparison unit that compares an identification result of at least one of the shelf space allocation state of the target product and the state of the surroundings of the target product with comparison information indicating one or more predetermined confirmation items for the target product; and
an output unit that outputs a comparison result between the identification result and the comparison information.
   2. The information processing apparatus according to supplementary note 1, further including:
an extraction unit that, when the target product is unprofitable in a plurality of shops, extracts and outputs a condition common to the plurality of shops with regard to a display state of the target product.
   3. The information processing apparatus according to supplementary note 2, in which
the extraction unit adds the output condition to the comparison information as a new confirmation item.
   4. The information processing apparatus according to any one of supplementary notes 1 to 3, in which
the comparison information includes, as the confirmation item, a recommended state for at least one of the shelf space allocation state of the target product and the state of the surroundings of the target product; and the output unit outputs a difference between the identification result and the recommended state.
   5. The information processing apparatus according to supplementary note 4, in which
the recommended state is determined based on at least one of a shelf space allocation state of the target product and a state of surroundings of the target product at another shop where sales of the target product exceed a criterion.
   6. The information processing apparatus according to any one of supplementary notes 1 to 5, in which
the comparison information includes, as the confirmation item, at least one of: a display position of the target product in the product shelf, a number of faces of the target product in the product shelf, an orientation of the target product in the product shelf, classifications of products displayed in the product shelf, a representative color of the products displayed in the product shelf, a shape of the products displayed in the product shelf, a relative position of the target product and an information display medium pertaining to the target product, and presence or absence of an obstacle located in front of the target product.
   7. An unprofitable product determination assistance method including:
by a computer,
processing an image of a product shelf in which a target product that is currently unprofitable in a shop is captured and identifying at least one of a shelf space allocation state of the target product and a state of surroundings of the target product;
comparing an identification result of at least one of the shelf space allocation state of the target product and the state of the surroundings of the target product with comparison information indicating one or more predetermined confirmation items for the target product; and
outputting a comparison result between the identification result and the comparison information.
   8. The unprofitable product determination assistance method according to supplementary note 7 further including:
by the computer, when the target product is unprofitable in a plurality of shops, extracting and outputting a condition common to the plurality of shops with regard to a display state of the target product.
   9. The unprofitable product determination assistance method according to supplementary note 8, in which
the computer adds the output condition to the comparison information as a new confirmation item.
   10. The unprofitable product determination assistance method according to any one of supplementary notes 7 to 9, in which
the comparison information includes, as the confirmation item, a recommended state for at least one of the shelf space allocation state of the target product and the state of surroundings of the target product; and the computer outputs a difference between the identification result and the recommended state.
   11. The unprofitable product determination assistance method according to supplementary note 10, in which
the recommended state is determined based on at least one of a shelf space allocation state of the target product and a state of surroundings of the target product at another shop where sales of the target product exceed a criterion.
   12. The unprofitable product determination assistance method according to any one of supplementary notes 7 to 11, in which
the comparison information includes, as the confirmation item, at least one of: a display position of the target product in the product shelf; a number of faces of the target product in the product shelf; an orientation of the target product in the product shelf; a classifications of products displayed in the product shelf; a representative color of the products displayed in the product shelf; a shape of the products displayed in the product shelf; a relative position of the target product and an information display medium pertaining to the target product; and presence or absence of an obstacle located in front of the target product.
   13. A program causing a computer to function as:
an image processing unit that processes an image of a product shelf in which a target product that is currently unprofitable in a shop is captured and identifies at least one of a shelf space allocation state of the target product and a state of surroundings of the target product;
a comparison unit that compares an identification result of at least one of the shelf space allocation state of the target product and the state of the surroundings of the target product with comparison information indicating one or more predetermined confirmation items for the target product; and
an output unit that outputs a comparison result between the identification result and the comparison information.
   14. The program according to supplementary note 13, further causing the computer to function as:
an extraction unit that, when the target product is unprofitable in a plurality of shops, extracts and outputs a condition common to the plurality of shops with regard to a display state of the target product.
   15. The program according to supplementary note 14, in which
the extraction unit adds the output condition to the comparison information as a new confirmation item.
   16. The program according to any one of supplementary notes 13 to 15, in which
the comparison information includes, as the confirmation item, a recommended state for at least one of the shelf space allocation state of the target product and the state of the surroundings of the target product; and the output unit outputs a difference between the identification result and the recommended state.
   17. The program according to supplementary note 16, in which
the recommended state is determined based on at least one of a shelf space allocation state of the target product and a state of surroundings of the target product at another shop where sales of the target product exceed a criterion.
   18. The program according to any one of supplementary notes 13 to 17, in which
the comparison information includes, as the confirmation item, at least one of: a display position of the target product in the product shelf; a number of faces of the target product in the product shelf; an orientation of the target product in the product shelf; classifications of products displayed in the product shelf; a representative color of the products displayed in the product shelf; a shape of the products displayed in the product shelf; a relative position of the target product and an information display medium pertaining to the target product; and presence or absence of an obstacle located in front of the target product.

### REFERENCE SIGNS LIST

1 Line product determination assistance system
10 Server apparatus
1010 Bus
1020 Processor
1030 Memory
1040 Storage device
1050 Input/output interface
1060 Network interface
110 Image processing unit
120 Comparison unit
130 Output unit
140 Extraction unit
142 Processing result accumulation unit
20 Shop assistant terminal

What is claimed is:

1. An information processing apparatus comprising:
at least one memory configured to store instructions; and
at least one processor configured to execute the instructions to perform operations: the operations comprising:
processing an image of a product shelf in which a target product that is currently unprofitable in a shop is captured and identifying at least one of a shelf space allocation state of the target product and a state of surroundings of the target product;
comparing an identification result of at least one of the shelf space allocation state of the target product and the state of the surroundings of the target product with comparison information indicating one or more predetermined confirmation items for the target product; and
outputting a comparison result between the identification result and the comparison information.

2. The information processing apparatus according to claim 1, wherein the operations further comprise
when the target product is unprofitable in a plurality of shops, extracting and outputting a condition common to the plurality of shops with regard to a display state of the target product.

3. The information processing apparatus according to claim 2, wherein
the operations further comprise adding the output condition to the comparison information as a new confirmation item.

4. The information processing apparatus according to claim 1, wherein
the comparison information includes, as the confirmation item, a recommended state for at least one of the shelf space allocation state of the target product and the state of the surroundings of the target product; and
the operations further comprise outputting a difference between the identification result and the recommended state.

5. The information processing apparatus according to claim 4, wherein
the recommended state is determined based on at least one of a shelf space allocation state of the target product and a state of surroundings of the target product at another shop where sales of the target product exceed a criterion.

6. The information processing apparatus according to claim 1, wherein
the comparison information includes, as the confirmation item, at least one of: a display position of the target product in the product shelf; a number of faces of the target product in the product shelf; an orientation of the target product in the product shelf; classifications of products displayed in the product shelf; a representative color of the products displayed in the product shelf; a shape of the products displayed in the product shelf; a relative position of the target product and an information display medium pertaining to the target product; and presence or absence of an obstacle located in front of the target product.

7. An unprofitable product determination assistance method including:
by a computer,
processing an image of a product shelf in which a target product that is currently unprofitable in a shop is captured and identifying at least one of a shelf space allocation state of the target product and a state of surroundings of the target product;
comparing an identification result of at least one of the shelf space allocation state of the target product and the state of the surroundings of the target product with comparison information indicating one or more predetermined confirmation items for the target product; and
outputting a comparison result between the identification result and the comparison information.

8. A non-transitory computer-readable medium storing a program causing a computer to perform operations, the operations comprising:
processing an image of a product shelf in which a target product that is currently unprofitable in a shop is captured and identifying at least one of a shelf space allocation state of the target product and a state of surroundings of the target product;
comparing an identification result of at least one of the shelf space allocation state of the target product and the state of the surroundings of the target product with comparison information indicating one or more predetermined confirmation items for the target product; and
outputting a comparison result between the identification result and the comparison information.
